(19) United States
(12) Patent Application Publication
(10) Pub. No.: US 2002/0089277 A1
(43) Pub. Date: Jul. 11, 2002

(54) Beam forming region having an array of emitting areas

(76) Inventor: Thomas Skupien, Buda, TX (US)

Correspondence Address: THOMAS ANDREW SKUPIEN, 237 BRADFIELD DRIVE, BUDA, TX, 78610, US

(21) Appl. No.: 10/038,995

(22) Filed: Jan. 5, 2002

Related U.S. Application Data
(60) Provisional application No. 60/261,046, filed on Jan. 11, 2001.

(51) Int. Cl. H01J 29/46

(52) U.S. Cl. 313/460

(57) ABSTRACT

A beam-forming region (BFR) such as used in cathode ray tube (CRT) electron guns includes a cathode, a decelerating first electrode (G1), an accelerating secondelectrode (G2), an accelerating third electrode (G3) and an additional electrode (G2′) that introduces a pre-focusing lens. The decelerating first electrode (G1) and the accelerating second electrode include aperture arrays that introduce multiple emitting areas on the surface of the cathode. Electrons emitted from the cathode surface pass through their respective apertures and are then converged into a single high current beam by the pre-focusing lens. The high current electron beam passes through any one of many possible main-lens structures, which focuses the beam onto a phosphorescent display screen. The beam is swept across the display screen in a rater like manner while being modulated by a video source signal. In an alternate embodiment, a large diameter aperture is included on the display screen side of the first accelerating electrode (G2) in order to form the pre-focusing lens and converge the electrons into a single high current beam.

### CROSS REFERENCE TO RELATED APPLICATIONS

This application is entitled to the benefit of Provisional Patent Application Ser No. 60/261,046 filed Jan. 11, 2000.

### BACKGROUND OF THE INVENTION

1. Field of the Invention

This invention relates to electron guns such as those used in cathode ray tubes (CRTs) and more specifically to a beam-forming region (BFR) of an electron gun having an array of cathode emitting areas.

2. Description of the Related Art

In recent years, due to technical advances in and general acceptance of flat panel displays, CRT design and development efforts have been directed toward more demanding applications such as high definition television (HDTV) displays, computer monitors, projection television receivers, wide-angle projectors, film recorders and diagnostic medical application.

The most important operating characteristics of CRT displays are typically video image brightness, resolution and display size. Unfortunately, these properties are interrelated. In a typical CRT, increasing brightness reduces the resolution because the electron beam spot size degrades. Increasing the display size reduces the video image brightness because the emitted light must cover a larger display area. Increasing the video image resolution by increases the scan frequency, decreases “dwell time.” This effectively reduces the beam current density striking the display screen and thus degrades the video image brightness.

One approach to providing acceptable video image brightness, at a given display size without appreciably diminishing image resolution, involves increasing the cathode emission current density. This approach greatly decreases the life of the cathode and thus the life of the CRT. So, the use of a dispenser cathode is sometime incorporated in the CRT. Dispenser cathodes can typically deliver five times the emission current density of a conventional oxide cathode and last over five times longer. While dispenser cathodes dramatically improving CRT life, the increased cathode emission current density does not appreciably improve the video image resolution or brightness. Also, dispenser cathodes are expensive costing approximately 50 times more than a convention oxide cathode.

One technique for increasing video image resolution without affecting the cathode emission current density is to increase the size of the electron gun. This allows for a smaller beam spot size and improved resolution, but increases the size of the CRT neck size. The increased size is contrary to the current trends, which seek to reduce the non-display screen portions of the CRT.

Another technique for achieving increased brightness and resolution involves the use of multi-beam electron guns. Conventional color CRTs employ three electron beams one for each of the primary colors (red, green and blue), while a monochrome CRT typically uses only one electron beam. In both cases the electron beams are swept across the CRT's display screen in a raster like manner. In multi-beam electron guns each of the standard electron beams are replaced with a group of electron beams.

An approach disclosed in the prior art is the use of a multi-beam electron gun to form distinctly separate mini-rasters on the CRT display screen. For example, Keller U.S. Pat. No. 3,943,281 shows a multi-beam electron gun where the beams crossover each other at a steep angle and strike the display screen at widely separated location. When these electron beams are swept in a raster like manner a plurality of mini-rasters is formed on the display screen. Each beam is modulated with a distinct section of the video signal appropriate for their location on the screen. The low-resolution mini-rasters combine to form a single high-resolution video image. This approach effectively divides the horizontal frequency of the deflection yoke by the number of mini-rasters being swept.

Another approach disclosed in prior art is the use of a multi-beam CRT to form alternating lines of video on the display screen. For example Chen U.S. Pat. Nos. 5,389,855; 5,350,978; 5,382,883 and Beck U.S. Pat. No. 4,338,541 both show designs that utilize multiple isolated electron beams that strike the display screen in close proximity to each other. The beams strike the display screen at separations equal to the line separation dictated by the display resolution. These separated beams are vertically aligned so that when they are swept across the display screen, in a raster like manner, each beam produces a line of video. Therefore the display can write a number of lines of video equal to the number of beams with each pass of the deflection yoke. This effectively divides the horizontal frequency of the deflection yoke by the number of beams being swept.

By Simultaneously tracing two or more horizontal scan lines, electron beam horizontal scan frequency and deflection frequency rate may be reduced and deflection yoke power requirements may be relaxed. The reduction in beam scan frequency gives rise to a corresponding increase in “dwell time” of the electron beams on the display screen's phosphor elements. Increasing electron beam dwell time allows for a corresponding reduction in electron beam peak current giving rise to a corresponding improvement in electron beam spot size and video image resolution without sacrificing video imaging brightness.

The problem with these types of multi-beam CRTs is that they require additional electronics in order to manipulate the video signal. These added components and design efforts could increase the manufacturing and selling cost of the display. CRT designers typically look for improvements that do not require extensive modification to the drive electronics.

Another problem with multi-beam CRT displays is that the electron guns are complicated and difficult to manufacture. These multi-beam guns typically send electron beams through the main lens optics off axis. Because of this, the guns require complicated electron optics to correct for beam position and focus quality. The complicated optics can adversely affect the manufacturing yields and increase costs.

Another approach disclosed in prior art utilizes multiple isolated electron beams, which are simultaneously swept across the display screen in order to form common lines of video on the display screen. For example Chen U.S. Pat. No. 5,389,855 describes an electron gun where separate beams are vertically aligned and superimposed on exactly the same location on the display screen. This effectively multiplies the video image brightness by the number of beams being swept without increasing the width of the lines of video on the display screen or increasing the required peak currents of the individual electron beams.

The problem with this approach is that the electron beams must be superimposed on precisely the same location on the display screen. If the beams are not perfectly “converged” then the electron beam spot size and video image resolution will be reduced according to the degree of mis-convergence. They require an exceptionally high performance “self converging deflection yoke.” Standard self-converging yokes, such as those used in color CRT displays, are of unacceptable quality. As a result these types of CRT displays are difficult to manufacture, which can be costly and could affect the manufacturing and selling cost of the displays.

Referring to FIG. 1, there is shown a simplified isometric view of a typical prior-art beam-forming region 112 of an electron gun such as that used in a CRT. A longitudinal sectional view of the beam-forming region 112 shown in FIG. 1 taken along site line 110-110 is shown in FIG. 2. Regardless of which of the preceding approaches is employed in the display, these CRTs all utilize electron guns that incorporate the standard prior-art beam-forming region (BFR) 112. The BFR 112 is designed to provide a method for cutting off and modulating an electron beam 126. The standard BFR 112 is comprised of four basic components a cathode 114, a “Wehnelt” or decelerating first electrode (G1) 116, an accelerating second electrode (G2) 118, and an accelerating third electrode (G3) 120. The electrodes 116, 118, 120 have apertures 116a, 118a, 120a that are linearly positioned.

In the conventional BFR 112 electrons are emitted from the cathode 114 and are accelerated toward the display screen by the G2 118 and the G3 120 electrodes, which are always of higher potential than the cathode 114. Along a path 122 toward the display screen the electrons pass through the G1 aperture 116a. The G1 electrode 116 is always of lower potential than the cathode 114. Thus the negatively charged G1 electrode 116 repels the electrons causing them to converge and “cross-over.” The electrons are now diverging and proceed to pass through the aperture in the G2 electrode 118a. Since the G3 electrode 120 is always of higher potential than the G2 electrode 118, the area between the G2 118 and G3 120 electrodes forms an accelerating lens 124. When the electrons pass through the accelerating lens 124 they become less divergent. The beam 126 is now “formed” and is sent through one of many types of main lens systems.

With this system the voltage on the G1 electrode 116 can be manipulated to allow more or fewer electrons to pass through the G1 aperture 116a. If the voltage that is applied to the G1 electrode 116 is sufficiently less than the voltage applied to the cathode 114 then the beam 126 will be “cut-off.” As the beam 126 is swept across the display screen in a raster like manner, the voltage applied to the G1 electrode 116 is modulated. The modulated G1 voltage changes the beam current and causes the varied brightness of the video image to be written on the display screen. The problem with the conventional BFR 112 is that it cannot meet the increasing requirements of larger display size, higher video image brightness and high resolution.

Referring to FIG. 3 there is shown a simplified isometric view of an alternate typical prior-art beam-forming region (BFR) 130 of an electron gun such as that used in a CRT, where an accelerating second electrode (G2) 136 is modified to introduce a pre-focusing lens 140. A longitudinal sectional view of the beam-forming region shown in FIG. 3 taken along site line 128-128 is shown in FIG. 4. The alternate BFR 130 is comprised of four basic components a cathode 132, a “Wehnelt” or decelerating first electrode (G1) 134, the accelerating second electrode (G2) 136, and an accelerating third electrode (G3) 138. The electrodes 134, 136, 138 have apertures 134a, 136a, 138a that are linearly positioned. The electrons emitted from the cathode 132 travel along a path 142 to the display screen and form a beam 144. In this BFR 130 the G2 aperture 136a diameter changes from one side of the G2 electrode 136 to the other. The G2 aperture 136a has a dimple which is a larger diameter on the display screen side 136c than on the cathode side 136b. The only functional difference compared to the conventional BRF 112 is that the high potential electric field of the accelerating third electrode (G3) 138 penetrates into the dimple of the G2 aperture 136c and thus introduces the pre-focusing lens 140. When the electrons pass through the pre-focusing lens 140 they are converged more so than in the conventional BFR 112. This BFR 130 is beneficial because the strength of the pre-focusing lens 140 can be adjusted by changing the diameter and depth of the dimple in the G2 aperture 136c. But, this adjustment is costly since the designer must re-tool the electrode each time an adjustment is made. Another drawback to this BFR 130 design is that it is more complicated and thus more difficult to manufacture than the conventional BFR 112.

Referring to FIG. 5 there is shown a simplified isometric view of an alternate typical prior-art beam-forming region 148 of an electron gun such as that used in a CRT, where an additional electrode (G2′) 156 is employed to introduce a pre-focusing lens 160. A longitudinal sectional view of the beam-forming region 156 shown in FIG. 5 taken along site line 146-146 is shown in FIG. 6. The alternate BFR 148 is comprised of five basic components a cathode 150, a “Wehnelt” or decelerating first electrode (G1) 52, an accelerating second electrode (G2) 154, the additional electrode (G2′) 156 and an accelerating third electrode (G3) 158. The electrodes 152, 154, 156, 158 have apertures 152a, 154a, 156a, 158a that are linearly positioned. The electrons emitted from the cathode 150 travel along a path 162 to the display screen and form a beam 164. This alternate BFR 148 uses the additional electrode (G2′) 156, disposed between the accelerating second electrode (G2) 154 and the accelerating third electrode (G3) 158, to introduce the pre-focusing lens 160. The G2′ 156 is always of lower potential than the G2 154. The high potential electric field of the accelerating third electrode (G3) 158 penetrates into the G2′ aperture 156a and thus introduces the pre-focusing lens 140. The only functional difference compared to a conventional BRF 112 is that when the electrons pass through the pre-focusing lens 160 they are converged more so than in the conventional BFR 112. This type of BFR 148 is beneficial because the strength of the pre-focus lens 160 can be adjusted by applying an additional potential to the isolated extra electrode 156. This method allows individual guns to be adjusted without the re-tooling of parts. Thus the optics of individual guns can be corrected for certain manufacturing errors. The draw back to the additional electrode 156 is that this BFR 148 is more difficult to manufacture than either of the previous BFRs 112, 130.

These methods of introducing the pre-focus lenses 140, 160 are used to control the electron beam diameter in the main lens system. The beam size must be optimized in order to achieve best video image resolution. The optimum beam size depends entirely on the main lens system and deflection system employed. If the beam is too large or too small for the main lens system or the deflection system then the video image resolution will be reduced.

These standard beam-forming regions 112, 130, 148 can be combined with any of the standard prior-art “main lens” systems to form conventional monochrome electron guns. The function of the main lens is to convert the diverging beam from the BFR 112, 130, 148 into a converging beam and focus it onto the display screen. The accelerating third electrode (G3) 120, 138, 158 of the BFR 112, 130, 148 is typically shared as the first electrode of the main lens. The G3 electrode 120, 138, 158 typically includes a drift region that isolates the BFR from the main lens. Conventional monochrome guns are classified as standard-einzel, high-einzel, bi-potential, or quad-potential based upon the main lens system employed. The name of each main lens is derived from the number of high potential electrodes utilized in the system.

Referring to FIG. 7 there is shown a simplified isometric view particularly in phantom of a typical prior-art electron gun 168 such as used in a conventional monochrome CRT with a conventional BFR 170 and a low uni-potential (standard-einzel) main lens 172. A longitudinal sectional view of the electron gun 168 shown in FIG. 7 taken along site line 166-166 is shown in FIG. 8. The standard-einzel main lens 172 is comprised of three electrodes. A first electrode (G3) 174 and a third electrode (G5) 178 are electrically connected and held at a high potential, which is equal to the display screen anode potential. A second electrode (G4) 176 is held near ground potential. The presence of the lower potential G4 electrode 176 between the two high potential G3 and G5 electrodes 174, 178 forms a converging main lens 172 that focuses an electron beam 180 onto the display screen. By adjusting the potential of the G4 electrode 176 the beam's focus can be fine adjusted to match the beam's location on the display screen.

Referring to FIG. 9 there is shown a simplified isometric view particularly in phantom of typical prior-art electron gun 184 such as used in a conventional monochrome CRT with a conventional BFR 186 and a high uni-potential (high-einzel) main lens 188. A longitudinal sectional view of the electron gun 184 shown in FIG. 9 taken along site line 182-182 is shown in FIG. 10. The high-einzel main lens 188 is similar in construction to the standard-einzel main lens 172. The high-einzel main lens 188 is comprised of three electrodes. A first electrode (G3) 190 and a third electrode (G5) 194 are electrically connected and held at anode potential. A second electrode (G4) 192 is held at a potential that is typically 20-40% of the anode potential. The potential of the G4 electrode 192 is used as the focusing adjustment for an electron beam 196. The only functional difference between the standard-einzel 172 and high-einzel 188 main lenses is that the high-einzel G4 192 is held at a high potential.

Referring to FIG. 11 there is shown a simplified isometric view particularly in phantom of typical prior-art electron gun 200 such as used in a conventional monochrome CRT with a conventional BFR 202 and a bi-potential main lens 204. A longitudinal sectional view of the electron gun shown in FIG. 11 taken along site line 198-198 is shown in FIG. 12. The bi-potential main lens 204 is comprised of two electrodes. A first electrode (G3) 206 is held at a high potential, which is typically 20-40% of the anode potential. A second electrode (G4) 208 is held at a high potential equal to the display screen anode potential. In this lens system the potential of the G3 electrode 206 is used as the focusing adjustment for an electron beam 210.

Referring to FIG. 13 there is shown a simplified isometric view particularly in phantom of a typical prior-art electron gun 214 such as used in a conventional monochrome CRT with a conventional BFR 216 and a quad-potential main lens 218. A longitudinal sectional view of the electron gun shown in FIG. 13 taken along site line 212-212 is shown in FIG. 14. The quad-potential main lens 218 is comprised of four electrodes. A first electrode (G3) 220 and a third electrode (G5) 224 are electrically connected and held at a high potential, typically 20-40% of the anode potential. A second (G4) 222 is held at low potential. A forth electrode (G6) 226 is held at anode potential. In this lens system the potential of the first (G3) 220 and third (G5) 224 electrodes are collectively used as the focusing adjustment for an electron beam 228.

The standard monochrome lens systems are used as the basis for the standard prior-art color electron gun configurations. Conventional color electron guns include three horizontally aligned electron beams, one for each of the primary phosphor colors, red, green and blue. Conventional color electron guns fall into one of two design schemes, “inline” and “Trinitron.”

Referring to FIG. 15 there is shown a simplified isometric view particularly in phantom of a typical prior-art electron gun 232 such as used in a conventional inline-color CRT with conventional BFRs 234a, 234b, 234c and bi-potential main-lenses 236a, 236b, 236c. A longitudinal sectional view of the electron gun 232 shown in FIG. 15 taken along site line 230-230 is shown in FIG. 16. In the inline color electron gun 232 three horizontally aligned beams 238a, 238b, 238c are sent through the distinctly isolated main-lenses 236a, 236b, 236c. The inline color electron gun 232 is essentially three separate electron guns assembled from common parts.

Referring to FIG. 17 there is shown a simplified isometric view particularly in phantom of a typical prior-art electron gun 242 such as is used in a conventional Trinitron-color CRT with conventional BFRs 244a, 244b, 244c and a high-einzel main-lens 246. A longitudinal sectional view of the trinitron electron gun 242 shown in FIG. 17 taken along site line 240-240 is shown in FIG. 18. In the Trinitron electron gun 242 three horizontally aligned beams 248a, 248b, 248c are sent at through the center of the common shared main-lens 242. The beams 248a, 248b, 248c are then redirected toward the display screen by a group of deflection plates 250a, 250b, 250c, 250d. The Trinitron electron gun has a larger diameter main-lens 246 than the inline color electron gun 232. For this reason the Trinitron electron gun 242 produces a higher resolution video image. But, the Trinitron electron gun 242 is more complicated and costly than the inline color electron gun 232.

### SUMMARY OF THE INVENTION

In view of the above problems, the present invention provides a beam-forming region (BFR) such as used in cathode ray tube (CRT) electron guns, which has multiple emitting areas on the cathode. This solves the problem of simultaneously achieving a large display size, high video image brightness and high resolution.

The present invention has the advantage of being a drop in replacement for any CRT electron gun's BFR. The present invention BFR can be substituted without changing the gun's main lens system therefore the present invention can be utilized in any type of monochrome or color CRT. The present invention has the further advantage of being a simple design and therefore easy and economical to manufacture. The present invention does not require modified or additional display electronics. The present invention does not requiring self-converging deflection yokes when used in monochrome CRT displays and does not requiring changes to the self-converging yoke when used in color CRT displays. The present invention has the advantage of being able to utilize any form of conventional CRT cathode, including field emitter array CRT cathodes.

This is accomplished by having multiple apertures in the decelerating first electrode (G1) and the accelerating second electrode (G2). The accelerating third electrode (G3) and subsequent electrodes remain unmodified. This method introduces multiple emitting areas on the cathode. The emitted convergent electrons cross over and pass through their respective G1 and G2 apertures. The electrons are then redirected to form a single high current beam. This design can be compared to a macroscopic version of a field emitter array (FEA).

The redirection of the electrons can be accomplished introducing a pre-focus lens. Any of the standard pre-focus methods can be employed for this purpose. The used of a dissimilar aperture diameters on either side of the accelerating second electrode (G2) provides a low cost version but allows for very little adjustability. The use of an additional electrode provides a higher cost version with the added advantage of adjustable pre-focus lens strength.

These and other features and advantages of the invention will be apparent to those skilled in the art from the following detailed description of preferred embodiments, taken together with the accompanying drawings, in which:

### BRIEF DESCRIPTION OF THE DRAWINGS

FIG. 1 is a simplified isometric view of a typical prior-art beam-forming region of an electron gun such as that used in a CRT.

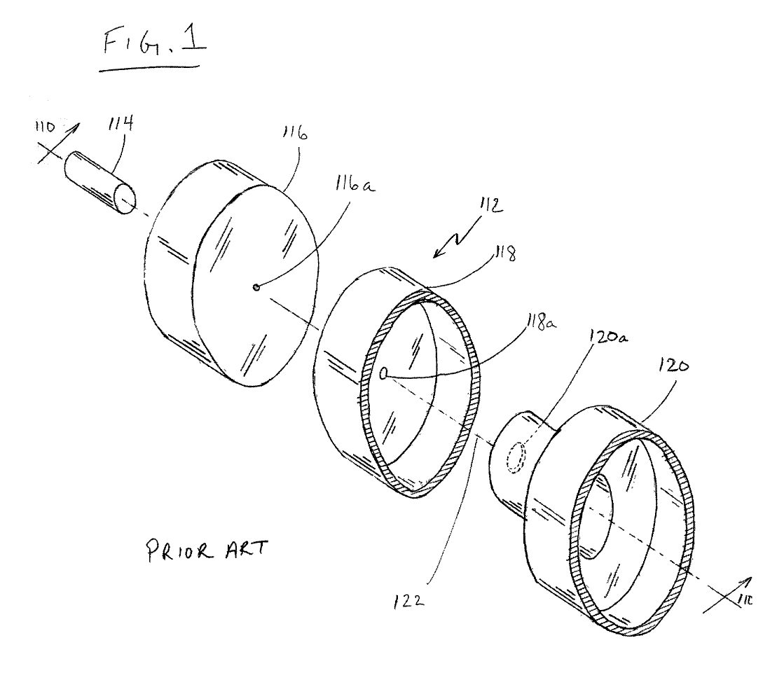

FIG. 2 is a longitudinal sectional view of the beam-forming region shown in FIG. 1 taken along site line 110-110.

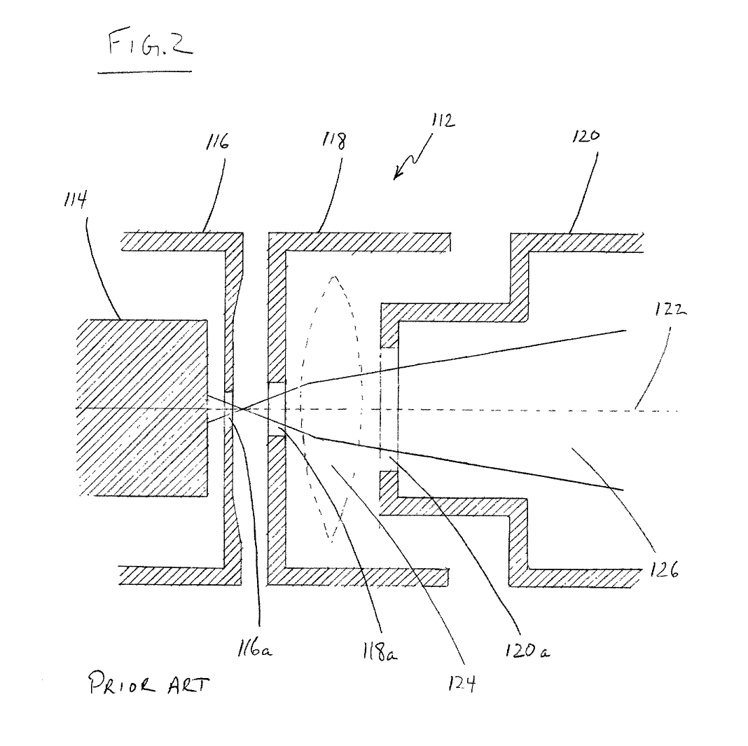

FIG. 3 is a simplified isometric view of an alternate typical prior-art beam-forming region of an electron gun such as that used in a CRT, where a grid element is modified to introduce beam pre-focusing.

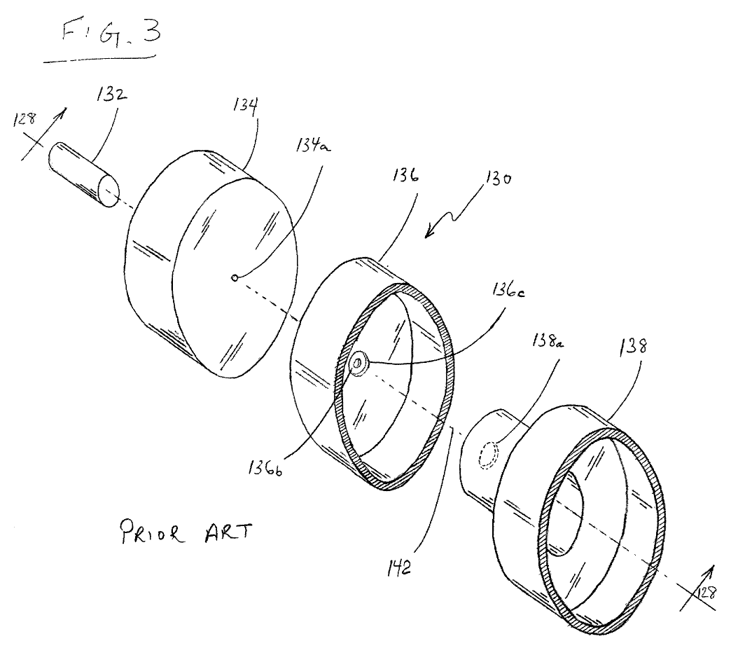

FIG. 4 is a longitudinal sectional view of the beam-forming region shown in FIG. 3 taken along site line 128-128.

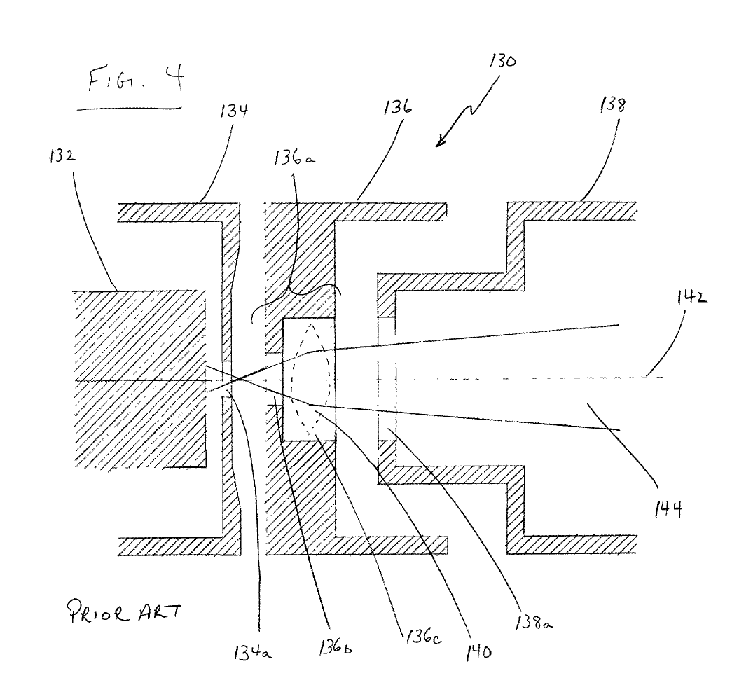

FIG. 5 is a simplified isometric view of an alternate typical prior-art beam-forming region of an electron gun such as that used in a CRT, where an extra grid element is employed to introduce beam pre-focusing.

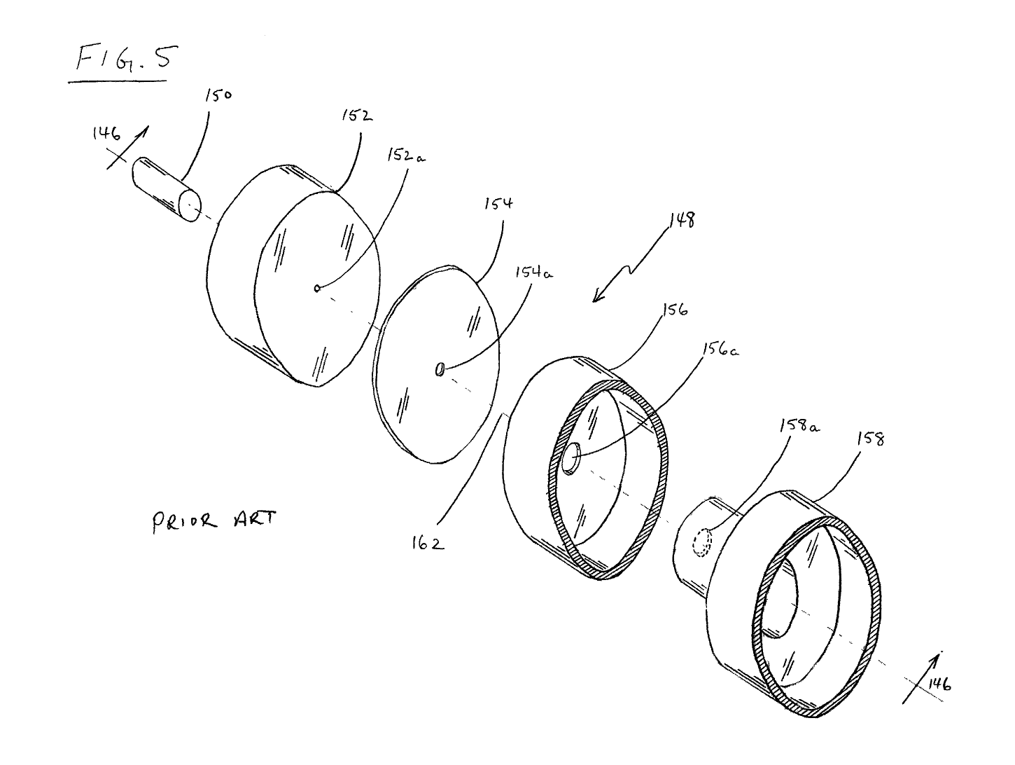

FIG. 6 is a longitudinal sectional view of the beam-forming region shown in FIG. 5 taken along site line 146-146.

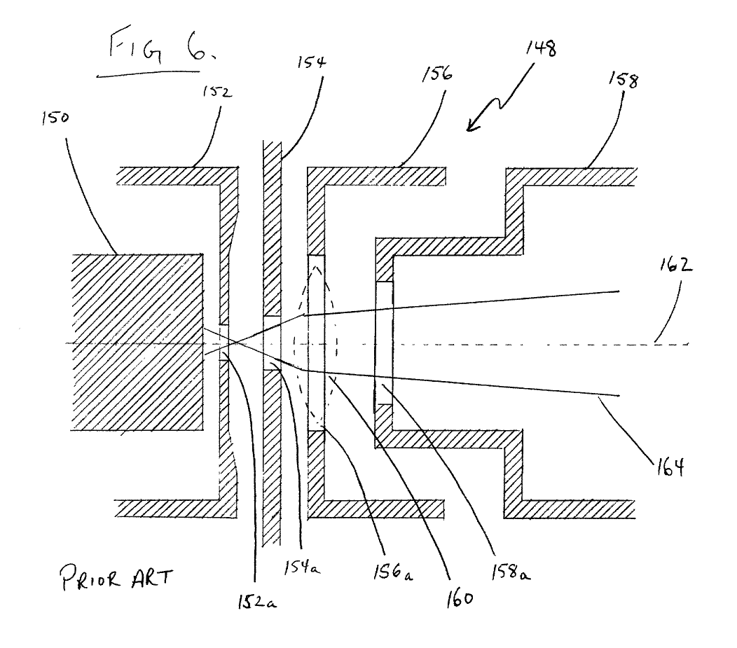

FIG. 7 is a simplified isometric view shown particularly in phantom of typical prior-art electron gun such as used in a conventional monochrome CRT with a low uni-potential (standard einzel) electrode configuration.

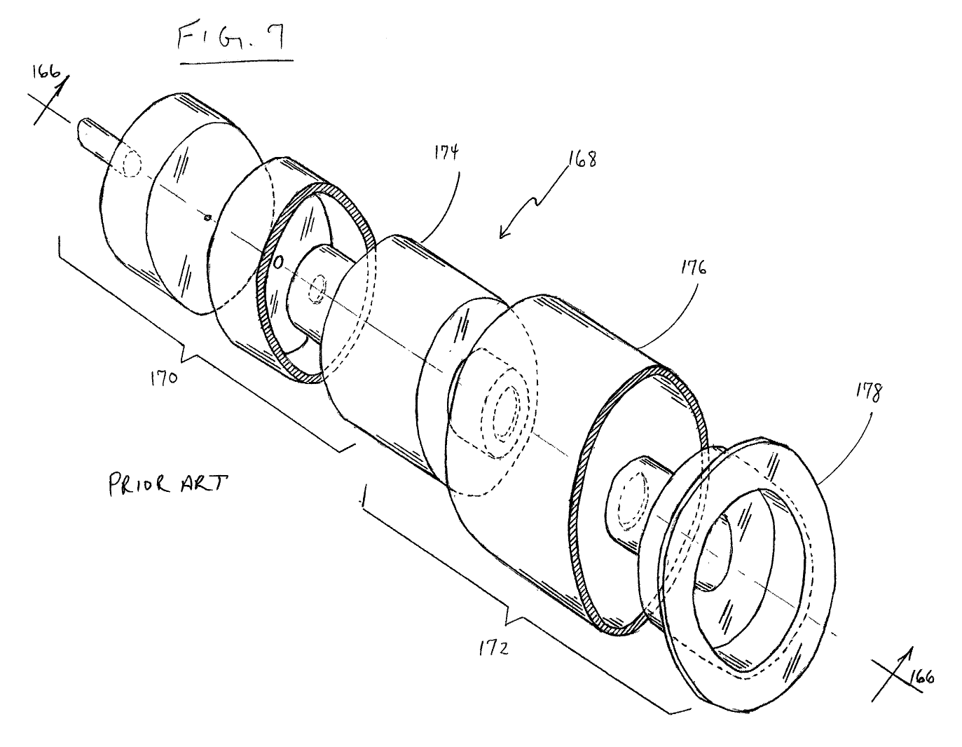

FIG. 8 is a longitudinal sectional view of the electron gun shown in FIG. 7 taken along site line 166-166.

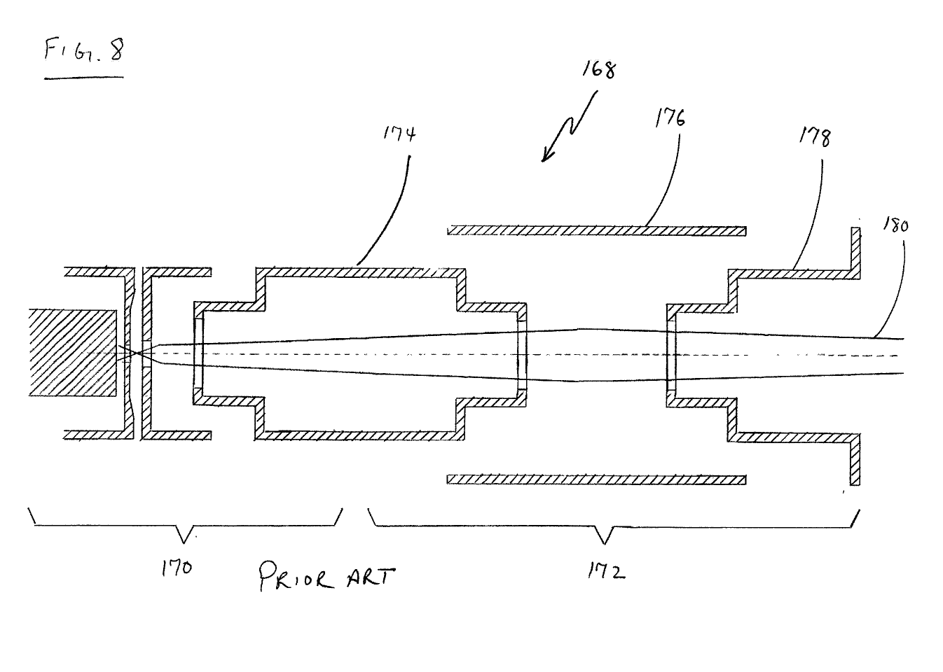

FIG. 9 is a simplified isometric view shown particularly in phantom of typical prior-art electron gun such as used in a conventional monochrome CRT with a high uni-potential (high-einzel) electrode configuration.

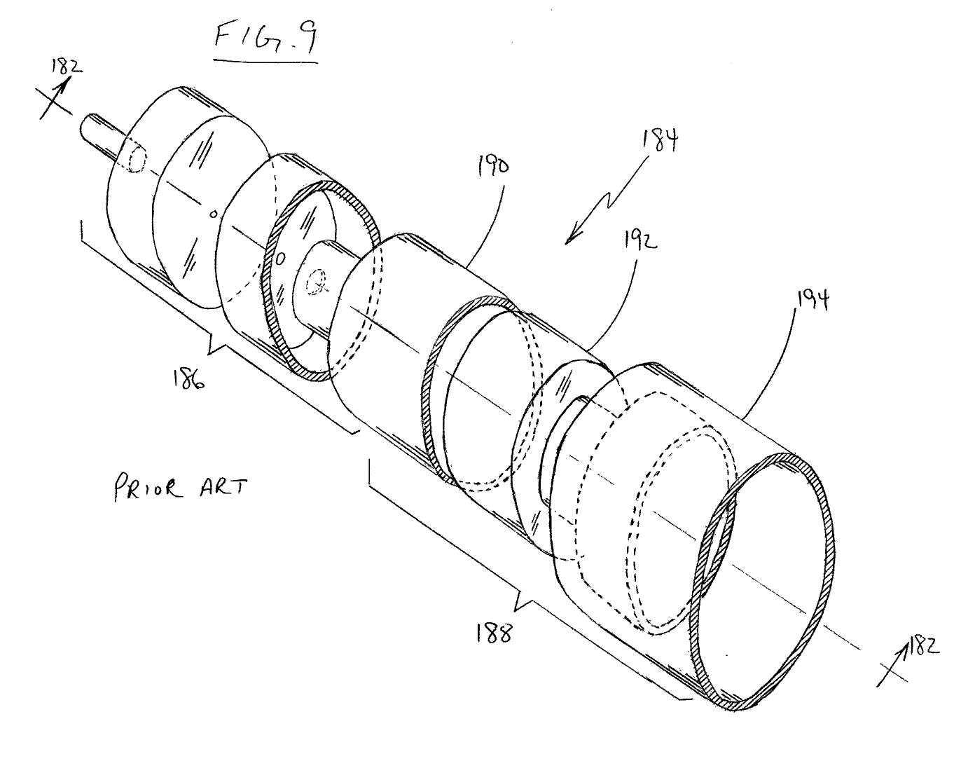

FIG. 10 is a longitudinal sectional view of the electron gun shown in FIG. 9 taken along site line 182-182.

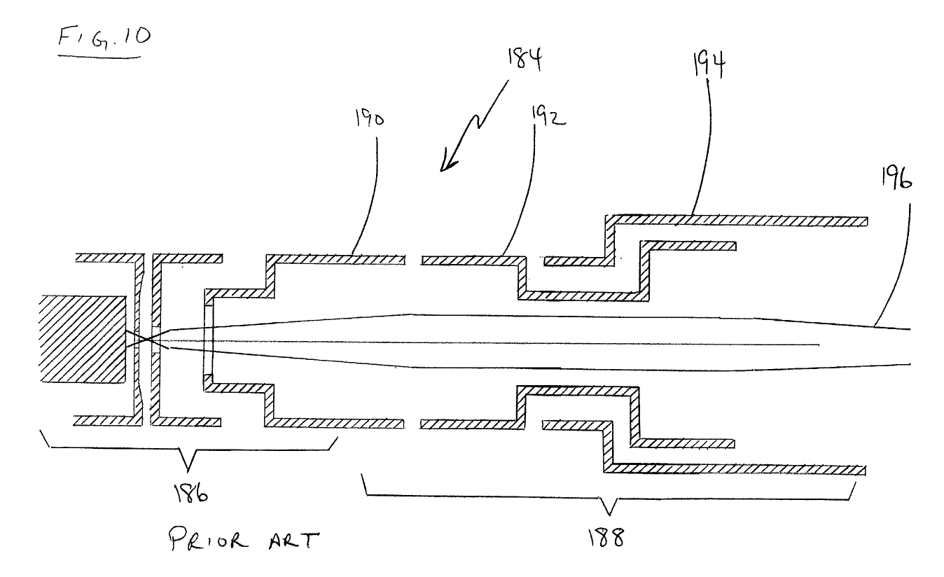

FIG. 11 is a simplified isometric view shown particularly in phantom of typical prior-art electron gun such as used in a conventional monochrome CRT with a bi-potential electrode configuration.

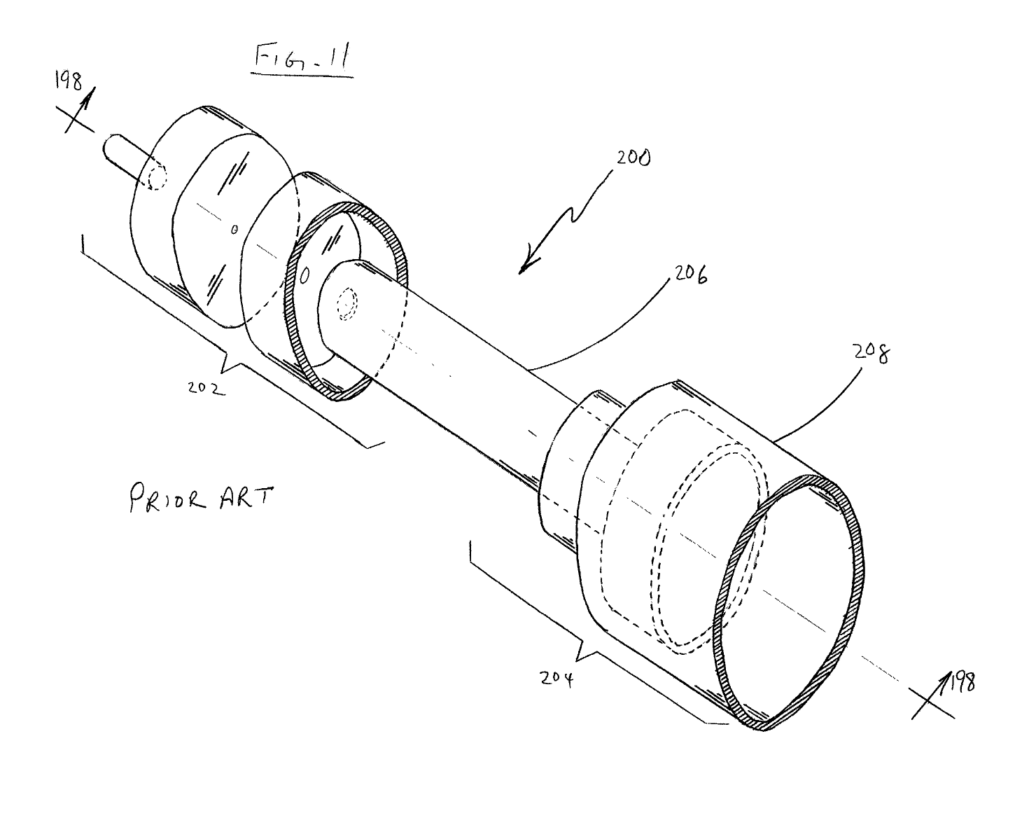

FIG. 12 is a longitudinal sectional view of the electron gun shown in FIG. 11 taken along site line 198-198.

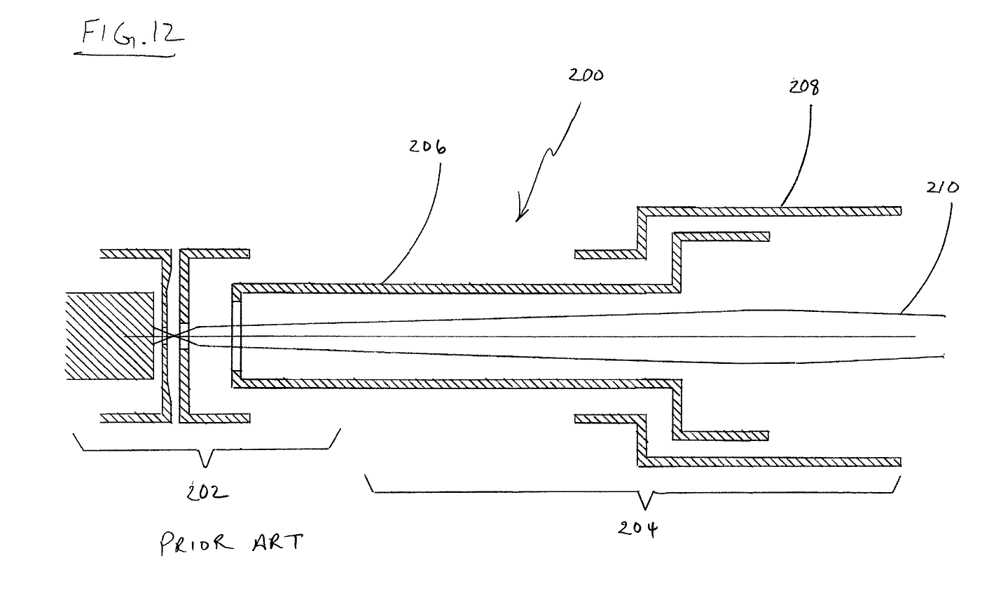

FIG. 13 is a simplified isometric view shown particularly in phantom of typical prior-art electron gun such as used in a conventional monochrome CRT with a quad-potential electrode configuration.

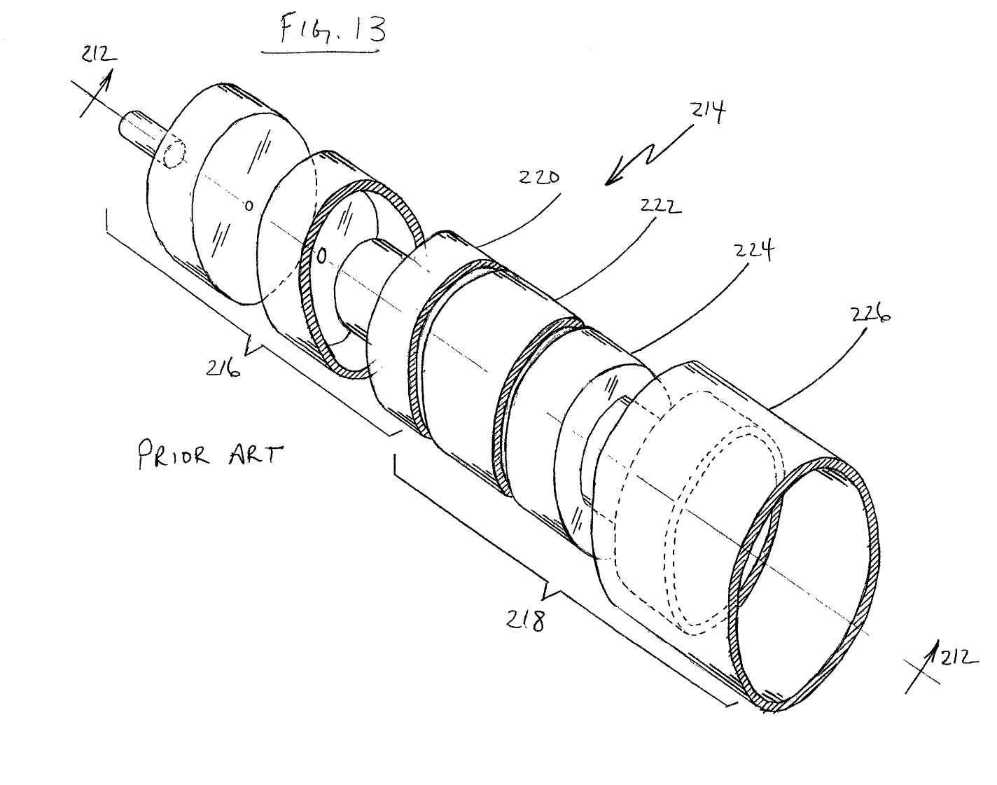

FIG. 14 is a longitudinal sectional view of the electron gun shown in FIG. 13 taken along site line 212-212.

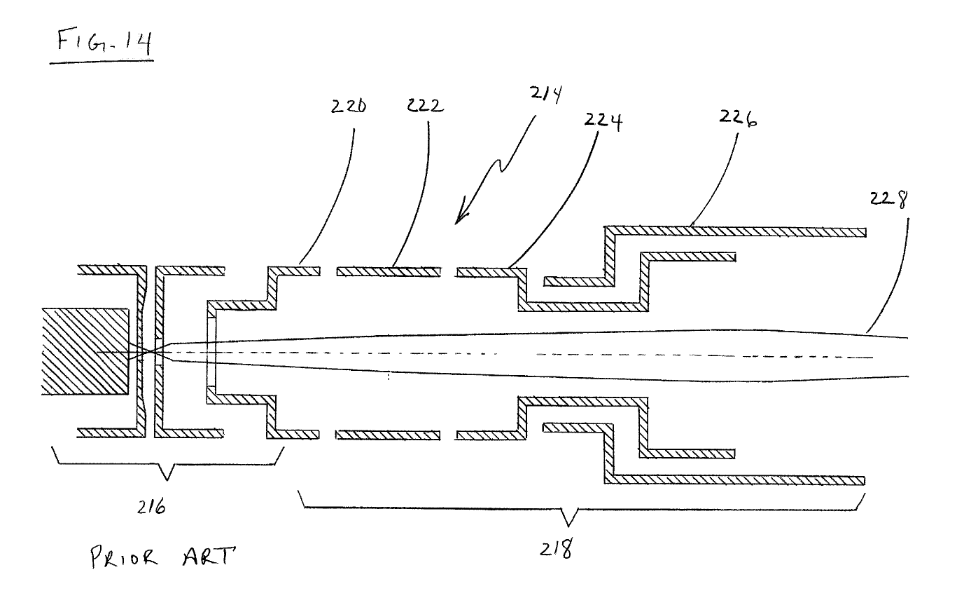

FIG. 15 is a simplified isometric view shown particularly in phantom of a typical prior-art electron gun such as used in a conventional inline-color CRT.

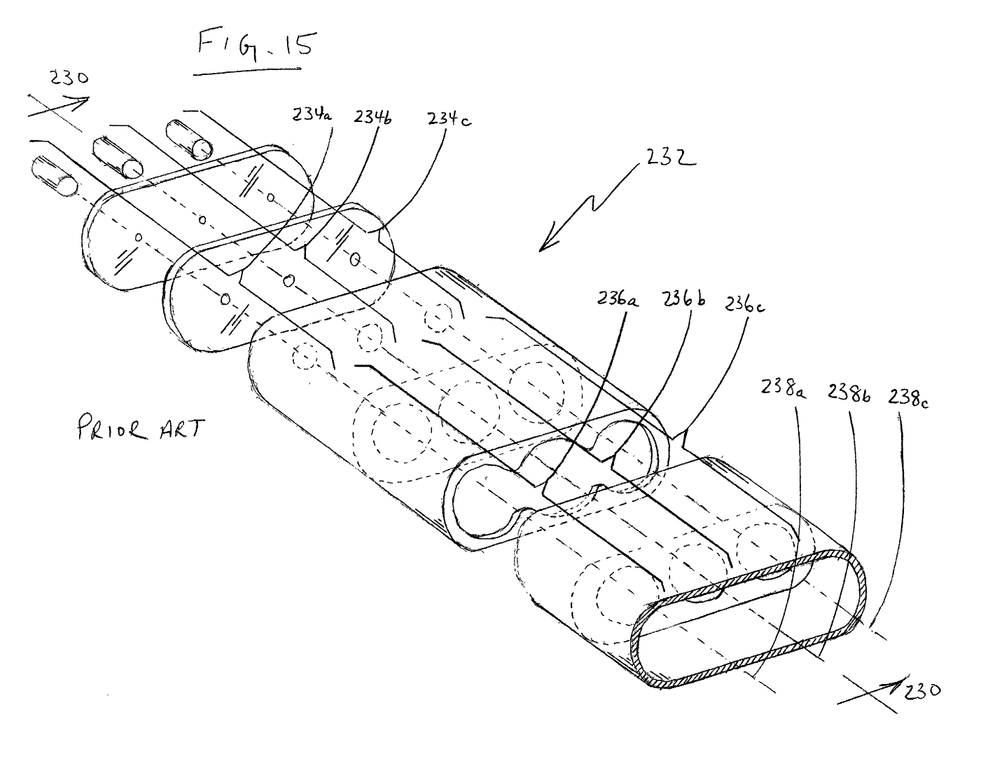

FIG. 16 is a longitudinal sectional view of the electron gun shown in FIG. 15 taken along site line 230-230.

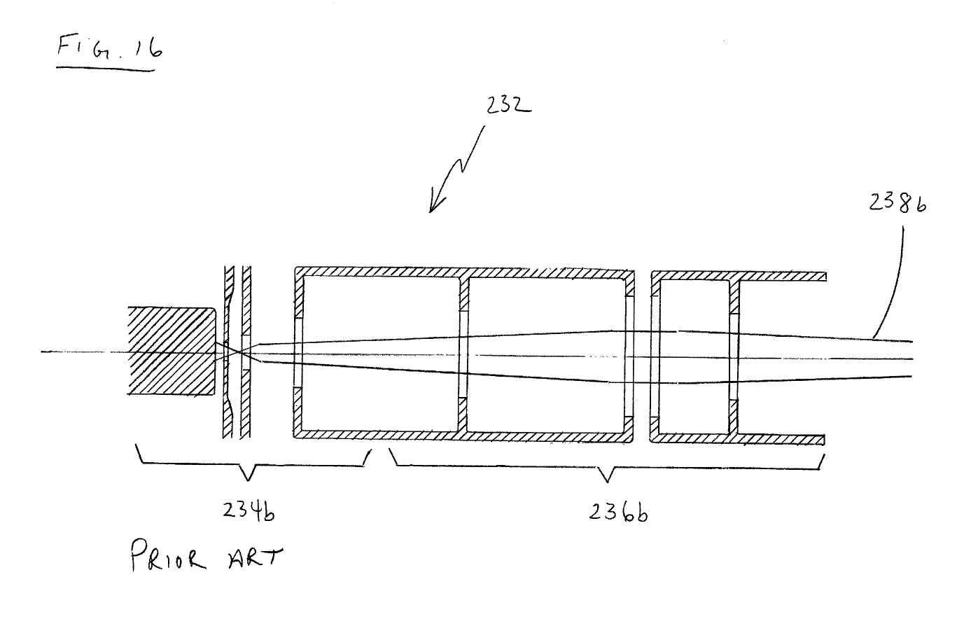

FIG. 17 is a simplified isometric view shown particularly in phantom of a typical prior-art electron gun such as is used in a conventional Trinitron-color CRT.

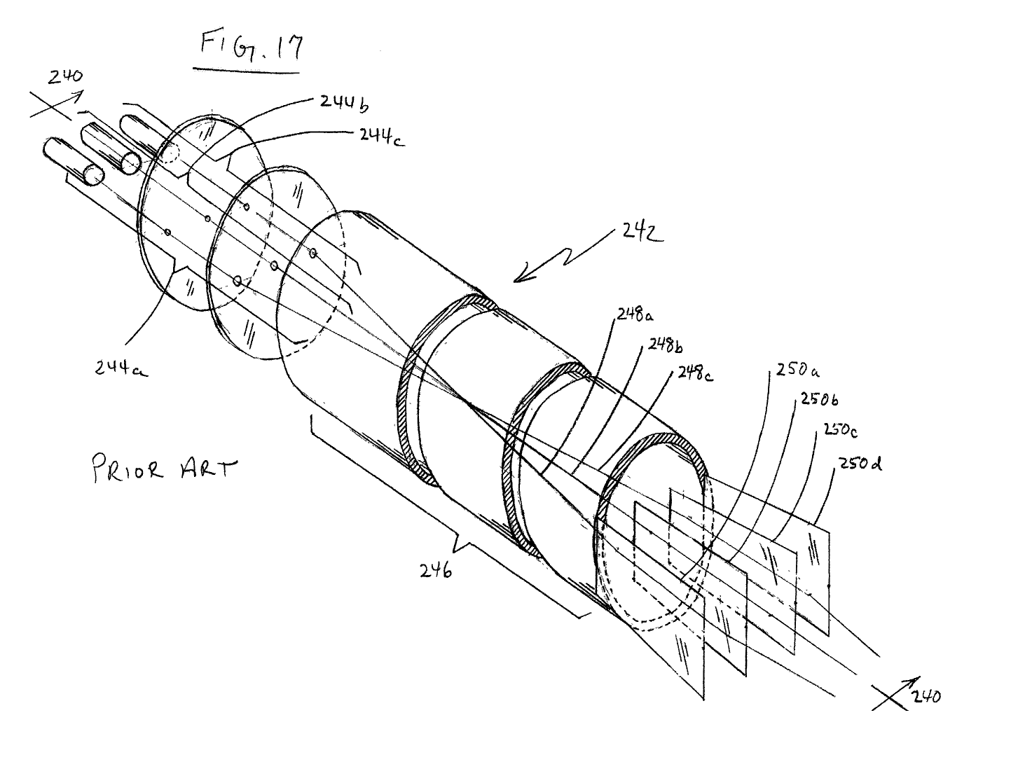

FIG. 18 is a longitudinal sectional view of the electron gun shown in FIG. 17 taken along site line 240-240.

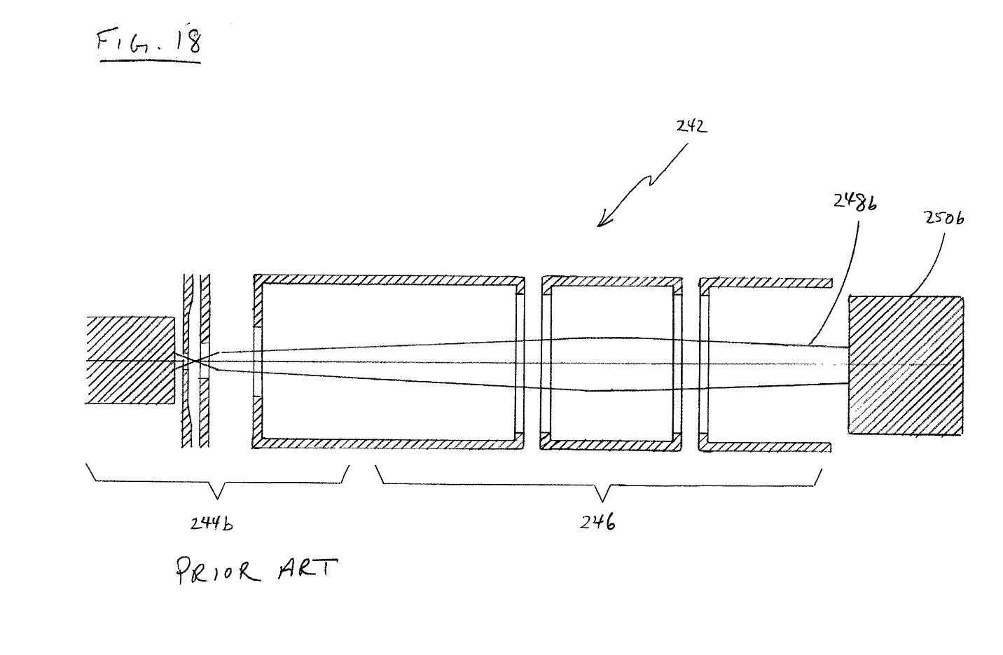

FIG. 19 is a simplified isometric view of a beam-forming region 254 of an electron gun such as used in a CRT in accordance with one embodiment of the present invention.

FIG. 20 is a longitudinal sectional view of the beam-forming region 254 shown in FIG. 19 taken along site line 252-252.

FIG. 21 is a simplified isometric view of a beam-forming region of an electron gun such as used in a CRT in accordance with an alternate embodiment of the present invention.

FIG. 22 is a longitudinal sectional view of the beam-forming region shown in FIG. 21 taken along site line 270-270.

FIG. 23 is a simplified isometric view shown particularly in phantom of an electron gun such as used in a conventional monochrome CRT in accordance with one embodiment of the present invention with a low uni-potential (standard einzel) electrode configuration.

FIG. 24 is a longitudinal sectional view of the electron gun shown in FIG. 23 taken along site line 290-290.

FIG. 25 is a simplified isometric view shown particularly in phantom of an electron gun such as used in a conventional monochrome CRT in accordance with one embodiment of the present invention with a high uni-potential (high-einsel) electrode configuration.

FIG. 26 is a longitudinal sectional view of the electron gun shown in FIG. 25 taken along site line 306-306.

FIG. 27 is a simplified isometric view shown particularly in phantom of an electron gun such as used in a conventional monochrome CRT in accordance with one embodiment of the present invention with a bi-potential electrode configuration.

FIG. 28 is a longitudinal sectional view of the electron gun shown in FIG. 27 taken along site line 322-322.

FIG. 29 is a simplified isometric view shown particularly in phantom of an electron gun such as used in a conventional monochrome CRT in accordance with one embodiment of the present invention with a quad-potential electrode configuration.

FIG. 30 is a longitudinal sectional view of the electron gun shown in FIG. 29 taken along site line 336-336.

FIG. 31 is a simplified isometric view shown particularly in phantom of an electron gun such as used in a conventional inline-color CRT in accordance with one embodiment of the present invention.

FIG. 32 is a longitudinal sectional view of the electron gun shown in FIG. 31 taken along site line 354-354.

FIG. 33 is a simplified isometric view shown particularly in phantom of an electron gun such as is used in a conventional Trinitron-color CRT in accordance with one embodiment of the present invention.

FIG. 34 is a longitudinal sectional view of the electron gun shown in FIG. 33 taken along site line 364-364.

### DETAILED DESCRIPTION OF THE INVENTION

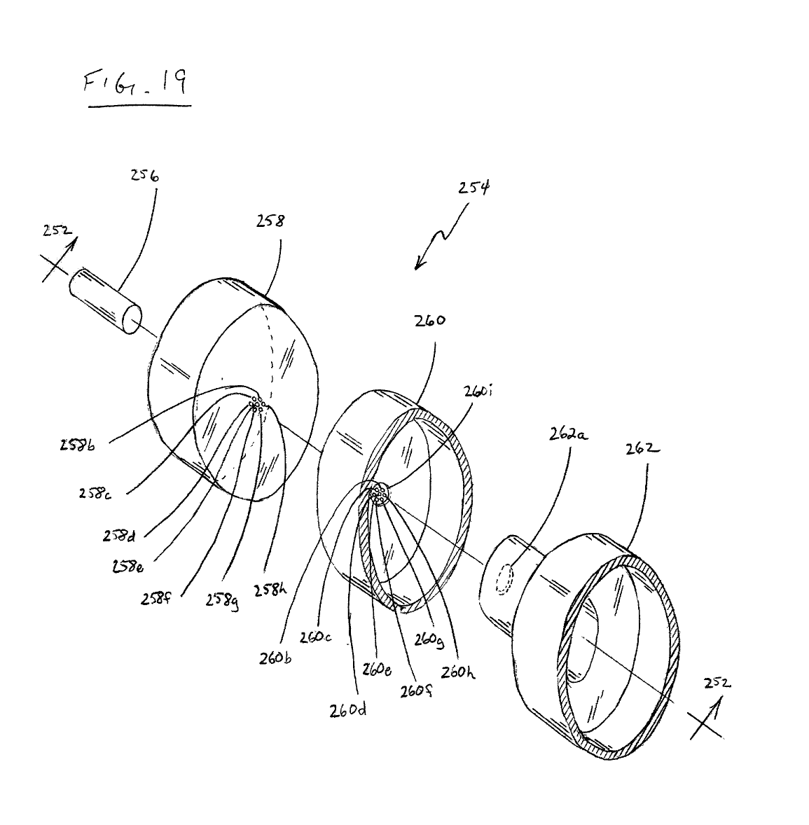

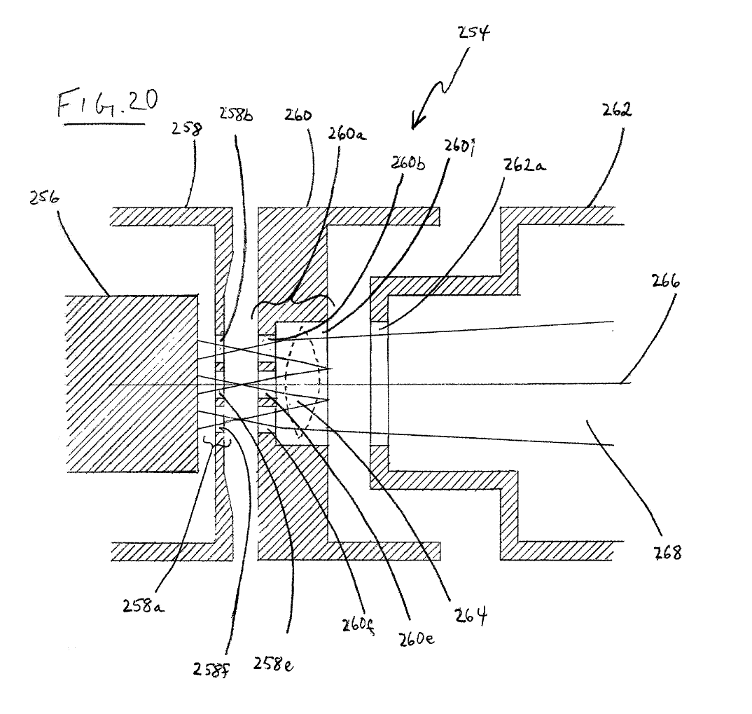

Referring to FIG. 19 there is shown a simplified isometric view of a beam-forming region 254 of an electron gun such as used in a CRT in accordance with one embodiment of the present invention. A longitudinal sectional view of the beam-forming region 254 shown in FIG. 19 taken along site line 252-252 is shown in FIG. 20. This BFR 254 is comprised of four components a cathode 256, a “Wehnelt” or decelerating first electrode (G1) 258, an accelerating second electrode (G2) 260, and an accelerating third electrode (G3) 262. The G1 and G2 electrodes 258, 260 have aperture arrays 258a, 260a that are linearly aligned with an aperture in the G3 electrode 262a. Electrons emitted from the cathode 256 travel along a path 266 to the display screen and form a beam 268. In this BFR 254 the G1 and G2 aperture arrays 258a, 260a are each comprised of seven smaller apertures 258b, 258c, 258d, 258e, 258f, 258g, 258h, 260b, 260c, 260d, 260e, 260f, 260g, 260h.

The aperture arrays 258a, 260a form multiple emitting areas on the surface of the cathode 254. In this BFR 112 electrons are emitted from the cathode 256 and are accelerated toward the display screen by the G2 260 and the G3 262 electrodes, which are always of higher potential than the cathode 254. Along the path 266 toward the display screen electrons pass through the G1 apertures 258b, 258c, 258d, 258e, 258f, 258g, 258h. Since the G1 electrode 258 is typically of a lower potential than the cathode 256, the negatively charged G1 electrode 258 repels the electrons causing them to converge and “cross-over.” The electron are now diverging and proceed to pass through their respective G2 apertures 260b, 260c, 260d, 260e, 260f, 260g, 260h. This BFR 254 is equipped with a dimple or single large diameter screen side of the aperture 260i. Since the G3 electrode 262 is typically of higher potential than the G2 electrode 260, the high potential field of the G3 electrode 262 penetrates into the large diameter portion of the G2 aperture 260i and thus introduces a pre-focusing lens 264. When electrons pass through the pre-focus lens 264 they are converged more so than in a conventional BFR 112. By converging the electrons the single high current electron beam 268 is formed and sent through one of many main lens systems. This BFR 254 is beneficial because the strength of the pre-focusing lens 264 can be adjusted by changing the diameter and depth of the large diameter screen side of the G2 aperture 260i.

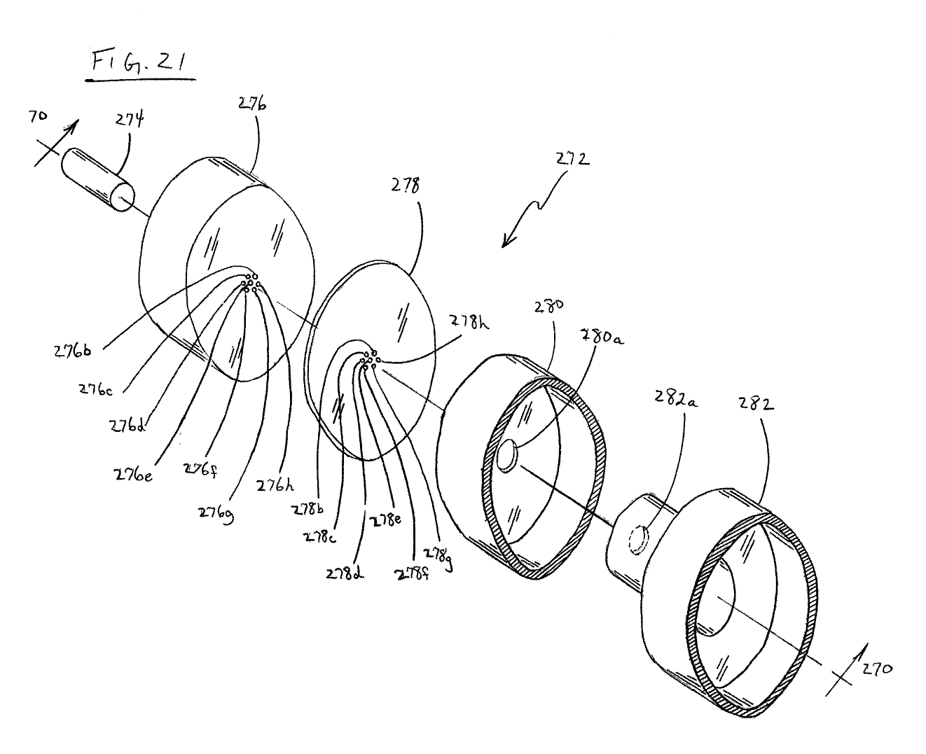

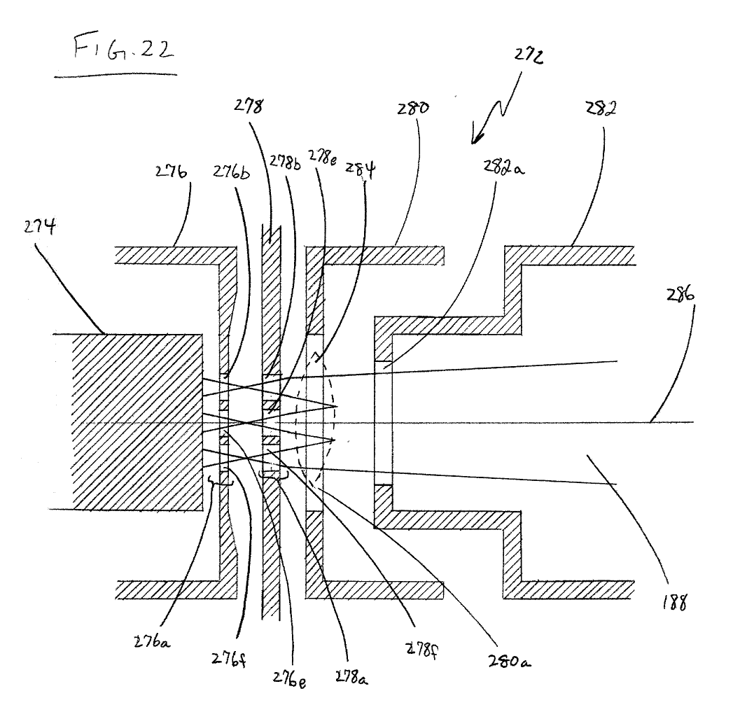

Referring to FIG. 21 there is shown a simplified isometric view of a beam-forming region of an electron gun such as used in a CRT in accordance with an alternate embodiment of the present invention, where an additional electrode (G2′) 280 is employed to introduce a pre-focusing lens 284. A longitudinal sectional view of the beam-forming region shown in FIG. 21 taken along site line 270-270 is shown in FIG. 22. The alternate BFR 272 is comprised of five basic components a cathode 274, a “Wehnelt” or decelerating first electrode (G1) 276, an accelerating second electrode (G2) 278, the additional electrode (G2′) 280 and an accelerating third electrode (G3) 282. The G1 and G2 electrodes 276, 278, have aperture arrays 276a, 278a that are linearly aligned with apertures in the G2′ and G3 electrodes 280a, 282a. Electrons emitted from the cathode 274 travel along a path 286 to the display screen and form a beam 288. In this BFR 272 the G1 and G2 aperture arrays 276a, 278a are each comprised of seven smaller apertures 276b, 276c, 276d, 276e, 276f, 276g, 276h, 278b, 278c, 278d, 278e, 278f, 278g, 278h.

This alternate BFR 272 uses the additional electrode (G2′) 280, inserted between the accelerating second electrode (G2) 278 and the accelerating third electrode (G3) 282, to introduce the pre-focusing lens 284. The G2′ 280 is always of lower potential than the G2 278. The high potential electric field of the second accelerating electrode (G3) 282 penetrates into the G2′ aperture 280a and thus introduces the pre-focusing lens 284. The predominant functional difference compared to the previous embodiment of the present inventive BRF 254 is that when the electrons pass through the pre-focusing lens 284 they are converged more or less depending on the potential of the G2′ electrode 280. This inventive BFR 272 is beneficial because the strength of the pre-focus lens 284 can be adjusted. This method allows individual guns to be adjusted without the re-tooling of parts.

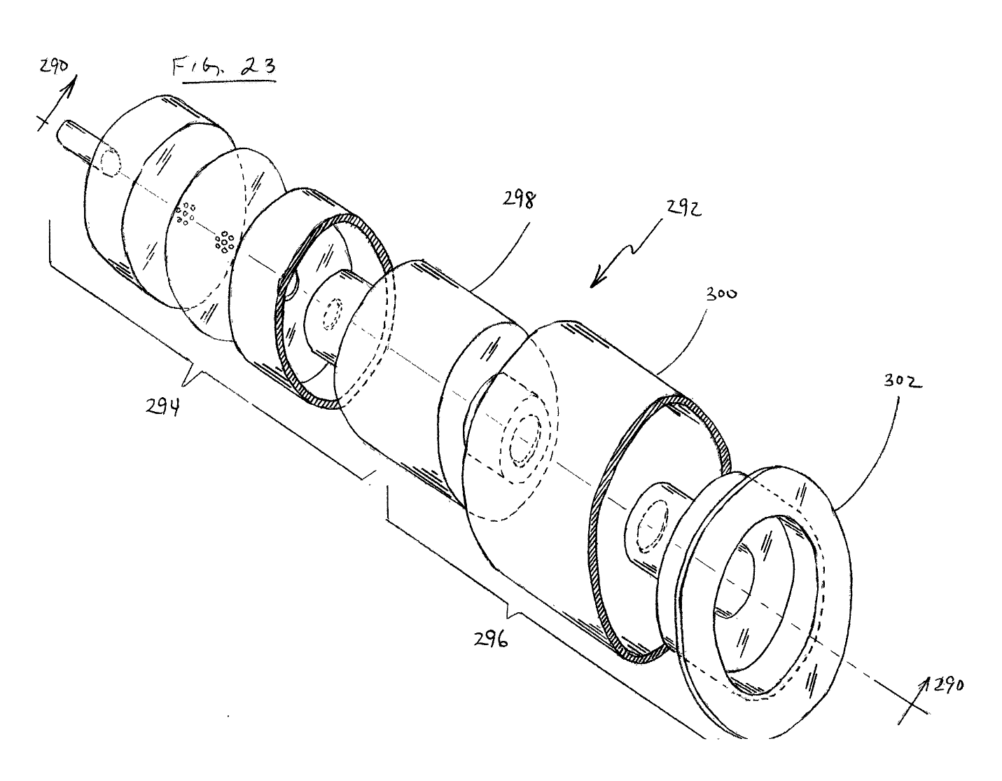

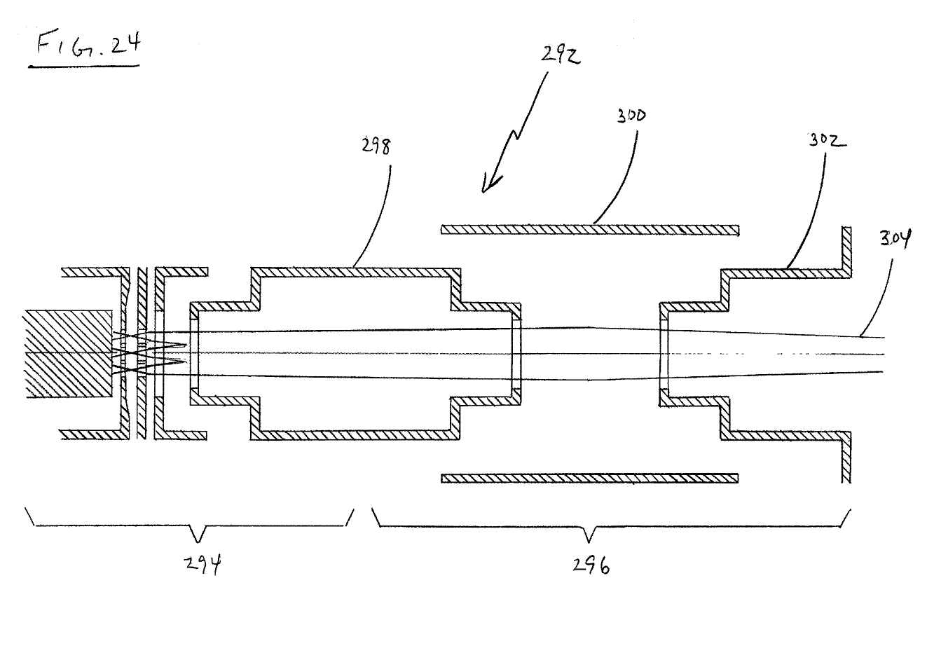

Referring to FIG. 23 there is shown a simplified isometric view particularly in phantom of an electron gun 292 such as used in a conventional monochrome CRT with a BFR 294 that is in accordance with one embodiment of the present invention and with a low uni-potential (standard einzel) electrode configuration. A longitudinal sectional view of the electron gun 292 shown in FIG. 23 taken along site line 290-290 is shown in FIG. 24. The standard-einzel main lens 296 is comprised of three electrodes. A first electrode (G3) 298 and a third electrode (G5) 302 are electrically connected and held at a high potential, which is equal to the display screen anode potential. A second electrode (G4) 300 is held near ground potential. The presence of the lower potential G4 electrode 300 between the two high potential G3 and G5 electrodes 298, 302 forms a converging main lens 296 that focuses an electron beam 304 onto the display screen. By adjusting the potential of the G4 electrode 300 the beam's focus can be fine adjusted to match the beam's location on the display screen.

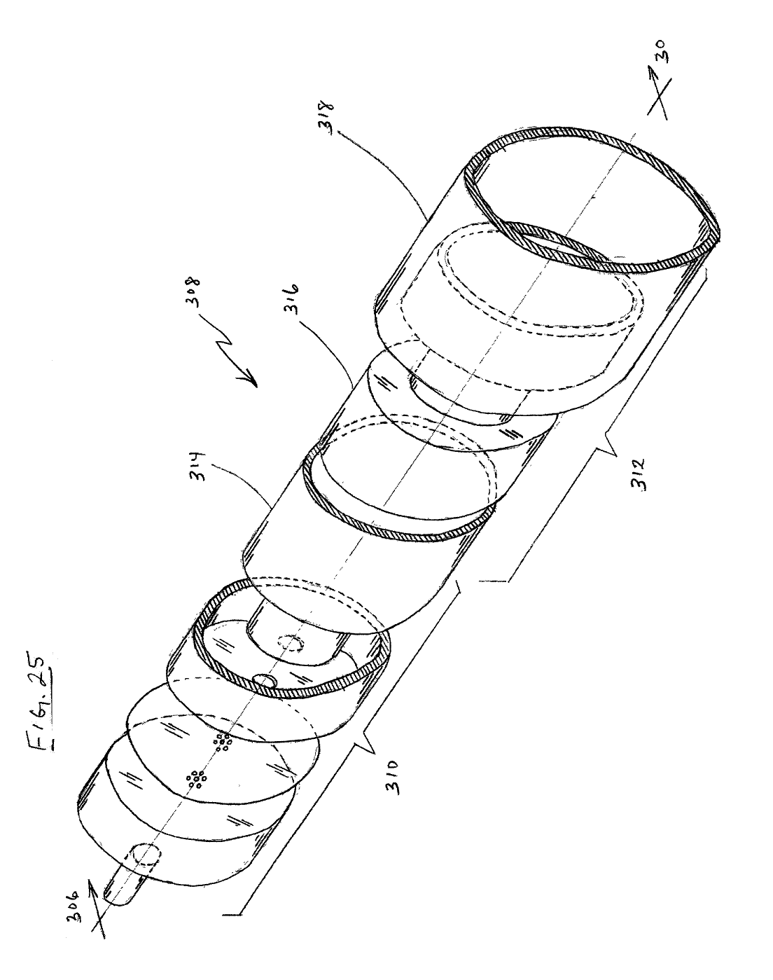

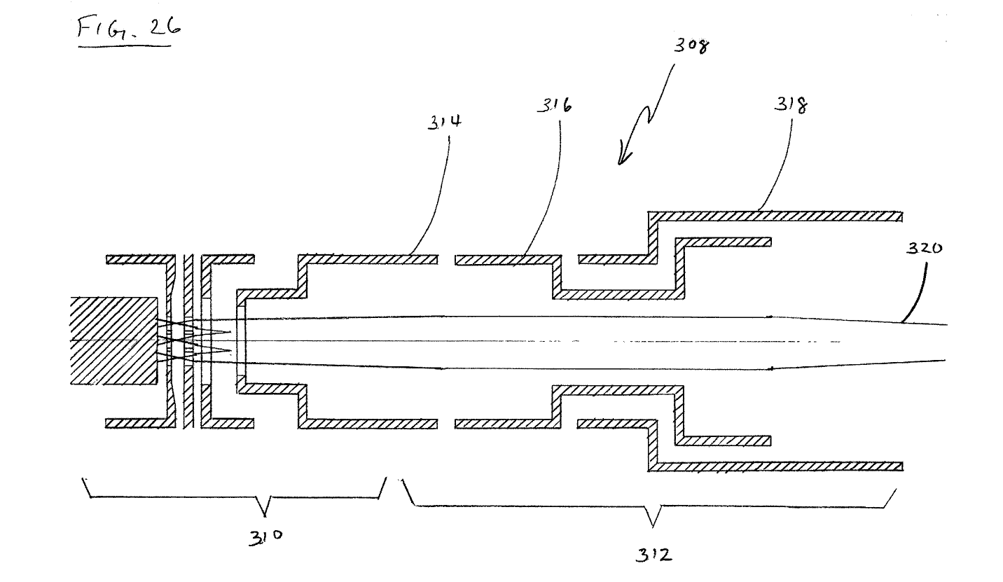

Referring to FIG. 25 there is shown a simplified isometric view shown particularly in phantom of an electron gun 308 such as used in a conventional monochrome CRT with a BFR 310 that is in accordance with one embodiment of the present invention and with a high uni-potential (high-einsel) electrode configuration. A longitudinal sectional view of the electron gun 308 shown in FIG. 25 taken along site line 306-306 is shown in FIG. 26. The high-einzel main lens 312 is similar in construction to the standard-einzel main lens 296. The high-einzel main lens 312 is comprised of three electrodes. A first electrode (G3) 314 and a third electrode (G5) 318 are electrically connected and held at anode potential. A second electrode (G4) 316 is held at a potential that is typically 20-40% of the anode potential. The potential of the G4 electrode 316 is used as the focusing adjustment for an electron beam 320. The only functional difference between the standard-einzel 296 and high-einzel 312 main lenses is that the high-einzel G4 316 is held at a high potential.

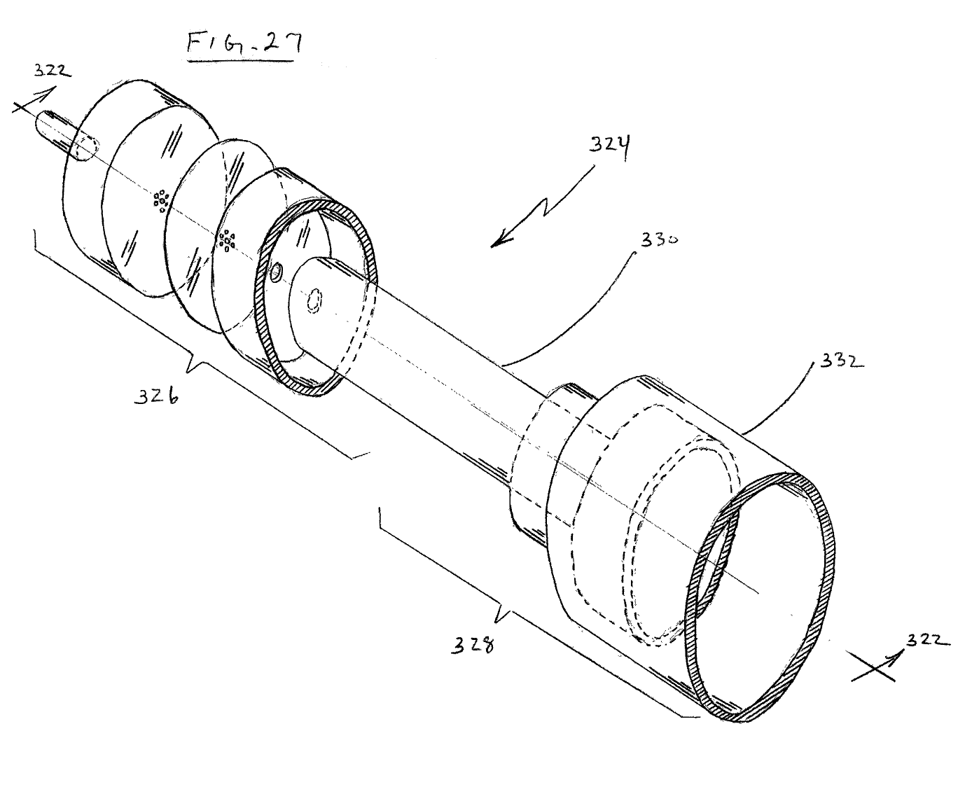

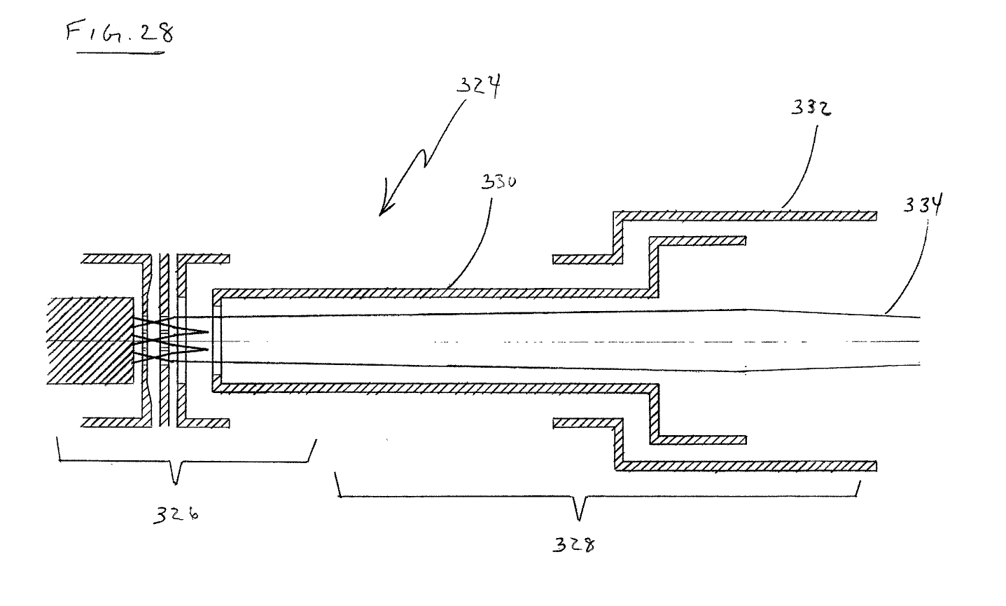

Referring to FIG. 27 there is shown a simplified isometric view shown particularly in phantom of an electron gun 324 such as used in a conventional monochrome CRT with a BFR 326 that is in accordance with one embodiment of the present invention and with a bi-potential electrode configuration. A longitudinal sectional view of the electron gun 324 shown in FIG. 27 taken along site line 322-322 is shown in FIG. 28. The bi-potential main lens 328 is comprised of two electrodes. A first electrode (G3) 330 is held at a high potential, which is typically 20-40% of the anode potential. A second electrode (G4) 232 is held at a high potential equal to the display screen anode potential. In this lens system the potential of the G3 electrode 330 is used as the focusing adjustment for an electron beam 334.

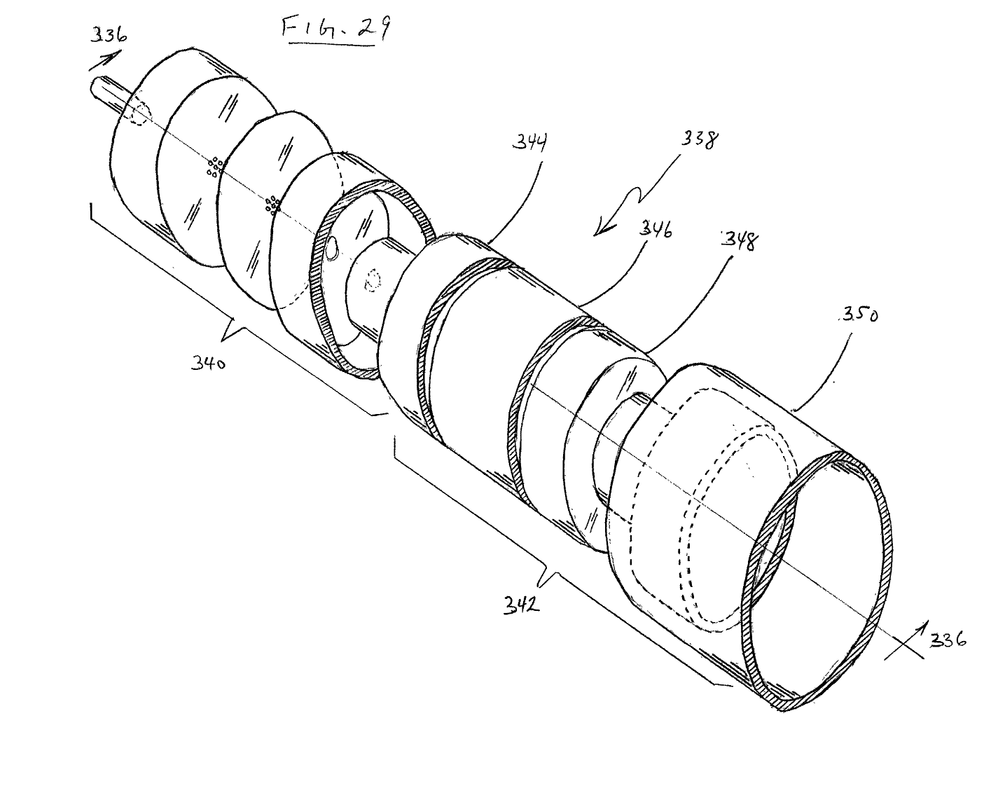

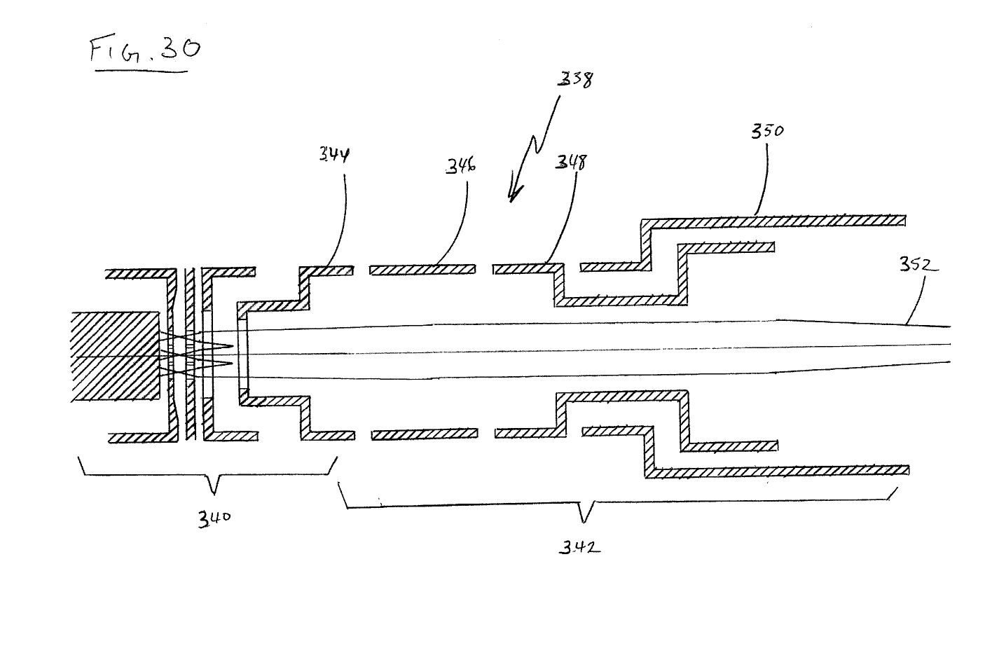

Referring to FIG. 29 there is shown a simplified isometric view shown particularly in phantom of an electron gun 338 such as used in a conventional monochrome CRT with a BFR 340 that is in accordance with one embodiment of the present invention with a quad-potential electrode configuration. A longitudinal sectional view of the electron gun 338 shown in FIG. 29 taken along site line 336-336 is shown in FIG. 30. The quad-potential main lens 342 is comprised of four electrodes. A first electrode (G3) 344 and a third electrode (G5) 348 are electrically connected and held at a high potential, typically 20-40% of the anode potential. A second (G4) 346 is held at low potential. A forth electrode (G6) 350 is held at anode potential. In this lens system the potential of the first (G3) 344 and third (G5) 348 electrodes are collectively used as the focusing adjustment for an electron beam 352.

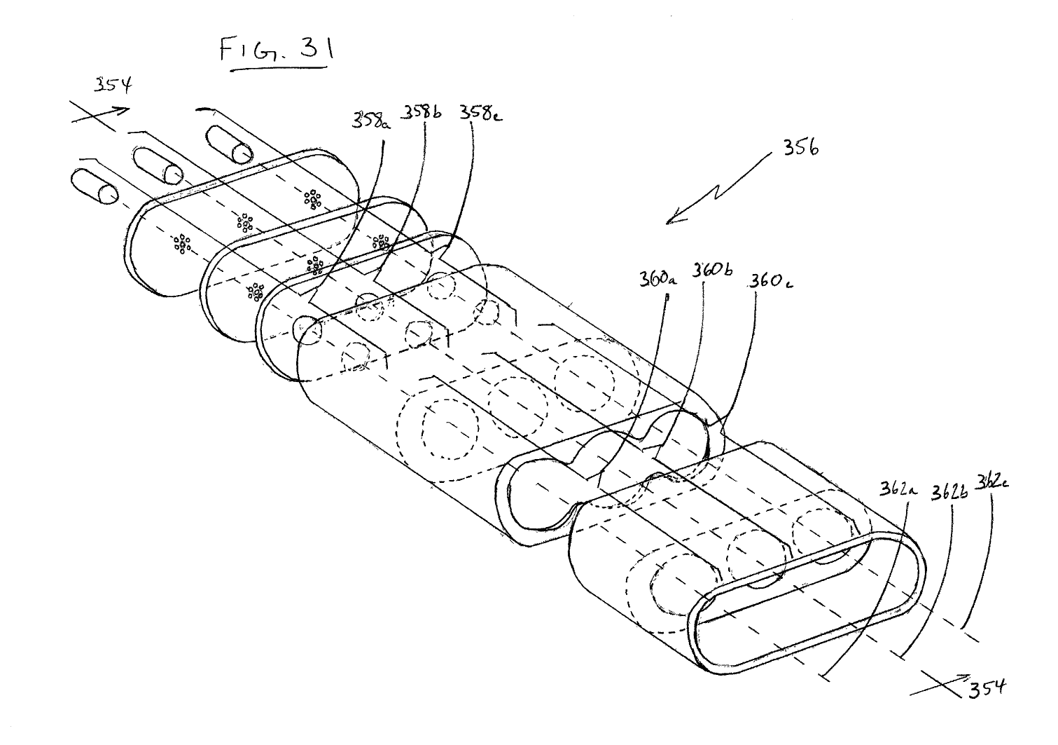

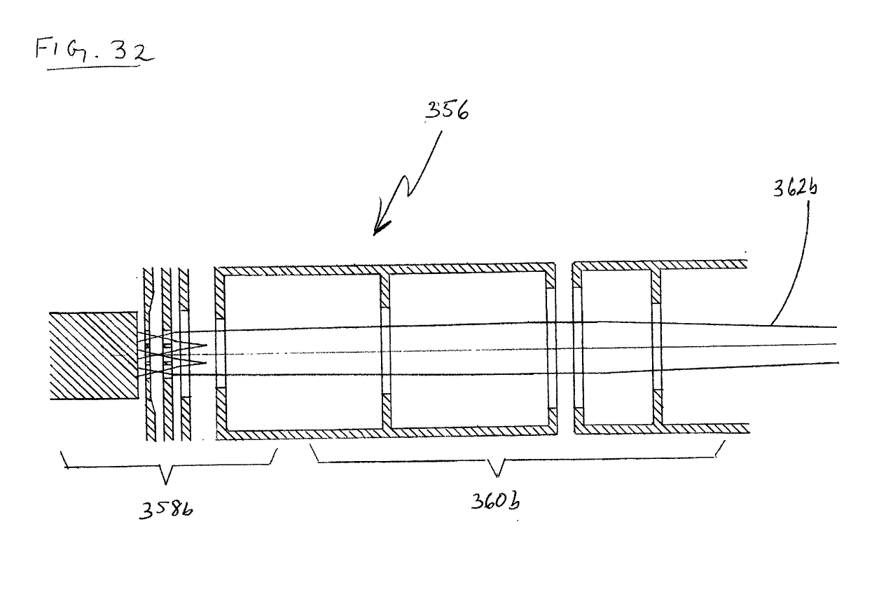

Referring to FIG. 31 there is shown a simplified isometric view shown particularly in phantom of an electron gun 356 such as used in a conventional inline-color CRT with BFRs 358a, 358b, 358c that are in accordance with one embodiment of the present invention. A longitudinal sectional view of the electron gun 356 shown in FIG. 31 taken along site line 354-354 is shown in FIG. 32. In the inline color electron gun 356 three horizontally aligned beams 362a, 362b, 362c are sent through the distinctly isolated main-lenses 360a, 360b, 360c. The inline color electron gun 356 is essentially three separate electron guns assembled from common parts.

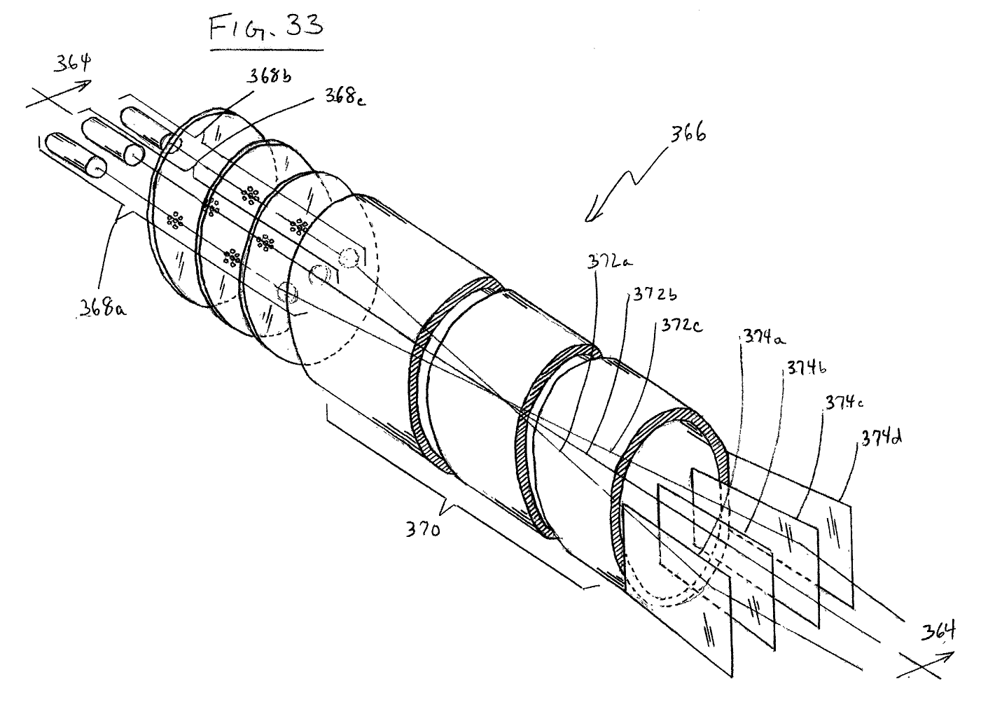

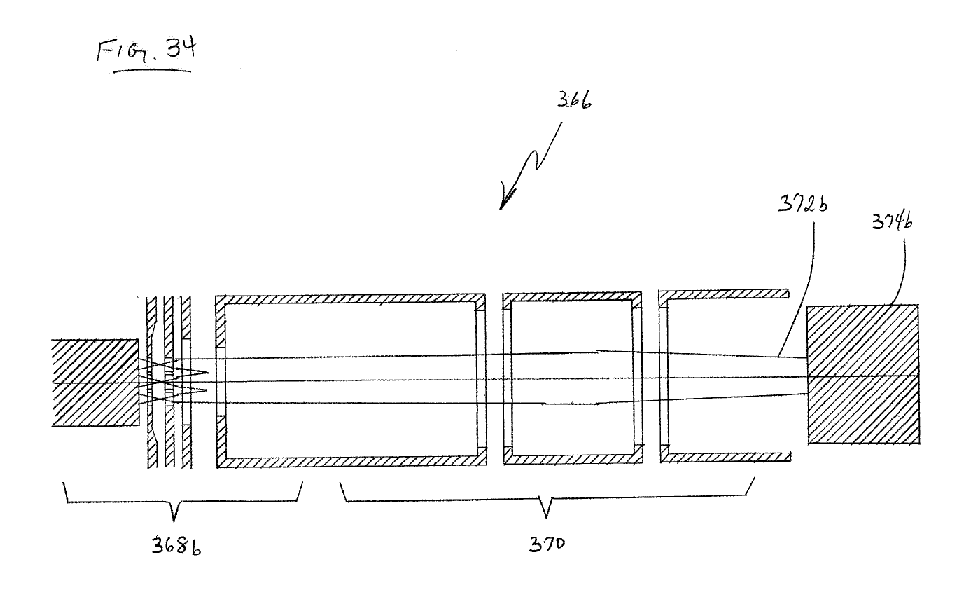

Referring to FIG. 33 there is shown a simplified isometric view shown particularly in phantom of an electron gun 366 such as is used in a conventional Trinitron-color CRT with BFRs 368a, 368b, 368c that are in accordance with one embodiment of the present invention. A longitudinal sectional view of the electron gun 366 shown in FIG. 33 taken along site line 364-364 is shown in FIG. 34. In the Trinitron electron gun 366 three horizontally aligned beams 372a, 372b, 372c are sent at through the center of the common shared main-lens 370. The beams 372a, 372b, 372c are then redirected toward the display screen by a group of deflection plates 374a, 374b, 374c, 374d.

While particular embodiments of the present invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention. The matter set forth in the foregoing description and accompanying drawings is offered by way of illustration only and not as a limitation. The actual scope of the invention is intended to be defined in the following claims when viewed in their proper perspective based on the prior art.

I claim:

1. A beam forming region of an electron gun for use in a cathode ray tube, comprising:
(a) a cathode for emitting electrons
(b) a first electrode, having a plurality of apertures
(c) a second electrode, having a plurality of apertures whereby the apertures in said first electrode and the apertures in said second electrode form a plurality of emission areas on the cathode
(d) a means of combining the electrons from the respective emission areas into a single beam whereby the beam is directed through a predetermined main lens.

2. The beam forming region of claim 1 wherein the electrons from said emission areas on the cathode pass through the respective apertures of the first and second electrodes, and the electrons crossover each other between the first and second electrodes.

3. The beam forming region of claim 1 wherein said means of combining the electrons comprises a depression in the second electrode.

4. The beam forming region of claim 1 wherein said means of combining the electrons comprises an additional electrode disposed between the second electrode and said predetermined main lens.

5. The beam forming region of claim 1 wherein the plurality of apertures in the first and second electrodes are disposed in a rotationally symmetric pattern.

6. The beam forming region of claim 1 wherein said cathode is of the field emission type.

7. A method of forming an electron beam of an electron gun for use in a cathode ray tube, comprising at least the steps of:
(a) extracting electrons from a plurality of areas of a cathode
(b) directing the electrons through a plurality of apertures in a first electrode
(c) directing the electrons through a plurality of apertures in a second electrode
(d) combining the electrons immerging from the respective apertures whereby the electrons form a single beam
(e) directing the beam through a predetermined main lens.

8. The method of forming an electron beam of claim 7 further including crossing over the electrons from the respective areas of the cathode between the first and second electrodes.

9. The method of forming an electron beam of claim 7 further including providing a depression in the second electrode.

10. The method of forming an electron beam of claim 7 further including providing an additional electrode disposed between the second electrode and said predetermined main lens.

11. The method of forming an electron beam of claim 7 further including arranging the apertures in the first and second electrodes in a rotationally symmetric pattern.

12. The method of forming an electron beam of claim 7 further including providing a field emission cathode.
